(19) United States
(12) Patent Application Publication
(10) Pub. No.: US 2009/0165380 A1
(43) Pub. Date: Jul. 2, 2009

(54) Petroleum Coke Compositions for Catalytic Gasification

(75) Inventors: Francis S. Lau, Darien, IL (US); Earl T. Robinson, Lakeland, FL (US)

Correspondence Address: MCDONNELL BOEHNEN HULBERT & BERGHOFF LLP, 300 S. WACKER DRIVE, SUITE 3100, CHICAGO, IL, 60606, US

(73) Assignee: GREATPOINT ENERGY, INC., Chicago, IL (US)

(21) Appl. No.: 12/342,608

(22) Filed: Dec. 23, 2008

Related U.S. Application Data
(60) Provisional application No. 61/017,303, filed on Dec. 28, 2007.

(51) Int. Cl. C10L 3/00; B01J 21/18

(52) U.S. Cl. 48/127.7; 502/184

(57) ABSTRACT

Particulate compositions are described comprising an intimate mixture of a petroleum coke and an alkali metal gasification catalyst, where the alkali metal gasification catalyst comprises a combination of an alkali metal hydroxide and one or more other alkali metal compounds are loaded onto coke for gasification in the presence of steam to yield a plurality of gases including methane and at least one or more of hydrogen, carbon monoxide, and other higher hydrocarbons are formed. Processes are also provided for the preparation of the particulate compositions and converting the particulate composition into a plurality of gaseous products.

### CROSS-REFERENCE TO RELATED APPLICATIONS

This application claims priority under 35 U.S.C. §119 from U.S. Provisional Application Ser. No. 61/017,303 (filed Dec. 28, 2007), the disclosure of which is incorporated by reference herein for all purposes as if fully set forth.

### FIELD OF THE INVENTION

The present invention relates to particulate compositions of petroleum coke and an alkali metal gasification catalyst having a combination of an alkali metal hydroxide and at least one other alkali metal compound. Further, the invention relates to processes for the preparation of the particulate compositions and for gasification of the same in the presence of steam to form gaseous products, and in particular, methane.

### BACKGROUND OF THE INVENTION

In view of numerous factors such as higher energy prices and environmental concerns, the production of value-added gaseous products from lower-fuel-value carbonaceous feedstocks, such as petroleum coke and coal, is receiving renewed attention. The catalytic gasification of such materials to produce methane and other value-added gases is disclosed, for example, in U.S. Pat. No. 3,828,474, U.S. Pat. No. 3,998,607, U.S. Pat. No. 4,057,512, U.S. Pat. No. 4,092,125, U.S. Pat. No. 4,094,650, U.S. Pat. No. 4,204,843, U.S. Pat. No. 4,468,231, U.S. Pat. No. 4,500,323, U.S. Pat. No. 4,541,841, U.S. Pat. No. 4,551,155, U.S. Pat. No. 4,558,027, U.S. Pat. No. 4,606,105, U.S. Pat. No. 4,617,027, U.S. Pat. No. 4,609,456, U.S. Pat. No. 5,017,282, U.S. Pat. No. 5,055,181, U.S. Pat. No. 6,187,465, U.S. Pat. No. 6,790,430, U.S. Pat. No. 6,894,183, U.S. Pat. No. 6,955,695, US2003/0167961A1, US2006/0265953A1, US2007/000177A1, US2007/083072A1, US2007/0277437A1 and GB 1599932.

Petroleum coke is a generally solid carbonaceous residue derived from delayed coking or fluid coking of a carbon source such as a crude oil residue. Petroleum coke in general has a poorer gasification reactivity, particularly at moderate temperatures, than does bituminous coal due, for example, to its highly crystalline carbon and elevated levels of organic sulfur derived from heavy-gravity oil. Use of catalysts is necessary for improving the lower reactivity of petroleum cokes. One advantageous catalytic process for gasifying petroleum cokes to methane

and other value-added gaseous products is disclosed in the above-mentioned US2007/0083072A1.

The reaction of petroleum coke alone can have very high theoretical carbon conversion (e.g., 98%), but has its own challenges including, but not limited to, maintaining bed composition, fluidization of the bed in the gasification reactor, control of possible liquid phases and agglomeration of the bed in the gasification reactor, and char withdrawal. Additionally, petroleum coke has inherently low moisture content, and a very low water soaking capacity to allow for conventional catalyst impregnation methods. Therefore, methods and compositions are needed which can support and provide a gasification catalyst for the gasification of petroleum coke.

### BRIEF DESCRIPTION OF THE DRAWINGS

FIG. 1 depicts the percentage of carbon conversion during gasification as a function of time for three petroleum coke particulate samples that were loaded with (i) only an alkali metal hydroxide, (ii) a combination of an alkali metal hydroxide and an alkali metal carbonate, and (iii) only an alkali metal carbonate.

### SUMMARY OF THE INVENTION

In one aspect, the present invention provides a particulate composition having a particle distribution size suitable for gasification in a fluidized bed zone, the particulate composition comprising an intimate mixture of (a) a petroleum coke and (b) an alkali metal gasification catalyst which, in the presence of steam and under suitable temperature and pressure, exhibits gasification activity whereby a plurality of gases including methane and at least one or more of hydrogen, carbon monoxide, carbon dioxide, hydrogen sulfide, ammonia and other higher hydrocarbons are formed, wherein: (i) the alkali metal gasification catalyst comprises a combination of an alkali metal hydroxide with one or more other alkali metal compounds selected from the group consisting of an alkali metal carbonate, alkali metal bicarbonate, alkali metal formate, alkali metal oxalate, alkali metal amide, alkali metal acetate, alkali metal sulfide, alkali metal halide, and alkali metal nitrate; (ii) the weight ratio of the alkali metal hydroxide to the other alkali metal compounds, in the alkali metal gasification catalyst, ranges from about 0.01 to about 0.5; (iii) the alkali metal gasification catalyst is present in an amount sufficient to provide, in the particulate composition, a ratio of alkali metal atoms to carbon atoms ranging from 0.01 to about 0.08; and (iv) the particulate composition has a moisture content of less than about 6 wt %, based on the weight of the particulate composition.

In a second aspect, the present invention provides a process for converting a particulate composition into a plurality of gaseous products comprising the steps of: (a) supplying a particulate composition according to first aspect to a gasifying reactor; (b) reacting the particulate composition in the gasifying reactor in the presence of steam and under suitable temperature and pressure to form a plurality of gaseous including methane and at least one or more of hydrogen, carbon monoxide, and other higher hydrocarbons; and (c) at least partially separating the plurality of gaseous products to produce a stream comprising a predominant amount of one of the gaseous products.

In a third aspect, the present invention provides a process for preparing a particulate composition of the first aspect, comprising the steps of: (a) providing petroleum coke particulates and an alkali metal gasification catalyst having a combination of an alkali metal hydroxide, and one or more other alkali metal compounds, wherein the alkali metal hydroxide is at least about 1 weight percent of the combined weight of the petroleum coke particulates and the alkali metal gasification catalyst; (b) contacting the coke particulates with an aqueous solution comprising the alkali metal gasification catalyst to form a slurry; (c) dewatering the slurry to form a wet coke cake loaded with the alkali metal gasification catalyst; and (d) drying the wet coke cake to produce a particulate composition having a moisture content of less than about 6 weight percent.

### DETAILED DESCRIPTION

The present invention relates to a particulate composition, methods for the preparation of the particulate composition, and methods for the catalytic gasification of the particulate composition. Generally, the particulate composition includes petroleum coke in various blends with, for example, an alkali metal hydroxide and at least one other alkali metal compound. Such particulate compositions can provide for an economical and commercially practical process for catalytic gasification of petroleum coke to yield methane and other value-added gases as a product. Such particulate compositions also serve to reduce or eliminate some technical challenges associated with the catalytic gasification of petroleum coke. The particulate compositions and processes described herein identify methods to use these particulate compositions in a commercially practical gasification process.

The present invention can be practiced, for example, using any of the developments to catalytic gasification technology disclosed in commonly owned US2007/0000177A1, US2007/0083072A1 and US2007/0277437A1; and U.S. patent application Ser. No. 12/178,380 (filed 23 Jul. 2008), Ser. No. 12/234,012 (filed 19 Sep. 2008) and Ser. No. 12/234,018 (filed 19 Sep. 2008). Moreover, the processes of the present invention can be practiced in conjunction with the subject matter of the following U.S. patent applications, each of which was filed on even date herewith: Ser. No. ______, entitled “CONTINUOUS PROCESSES FOR CONVERTING CARBONACEOUS FEEDSTOCK INTO GASEOUS PRODUCTS” (attorney docket no. FN-0018 US NP1); Ser. No. ______, entitled “CATALYTIC GASIFICATION PROCESS WITH RECOVERY OF ALKALI METAL FROM CHAR” (attorney docket no. FN-0007 US NP1); Ser. No. ______, entitled “PETROLEUM COKE COMPOSITIONS FOR CATALYTIC GASIFICATION” (attorney docket no. FN-0008 US NP1); Ser. No. ______, entitled “CARBONACEOUS FUELS AND PROCESSES FOR MAKING AND USING THEM” (attorney docket no. FN-0013 US NP1); Ser. No. ______, entitled “CATALYTIC GASIFICATION PROCESS WITH RECOVERY OF ALKALI METAL FROM CHAR” (attorney docket no. FN-0014 US NP1); Ser. No. ______, entitled “COAL COMPOSITIONS FOR CATALYTIC GASIFICATION” (attorney docket no. FN-0009 US NP1); Ser. No. ______, entitled “PROCESSES FOR MAKING SYNTHESIS GAS AND SYNGAS-DERIVED PRODUCTS” (attorney docket no. FN-0010 US NP1); Ser. No. ______, entitled “CATALYTIC GASIFICATION PROCESS WITH RECOVERY OF ALKALI METAL FROM CHAR” (attorney docket no. FN-0015 US NP1); Ser. No. ______, entitled “CATALYTIC GASIFICATION PROCESS WITH RECOVERY OF ALKALI METAL FROM CHAR” (attorney docket no. FN-0016 US NP1); Ser. No. ______, entitled “STEAM GENERATING SLURRY GASIFIER FOR THE CATALYTIC GASIFICATION OF A CARBONACEOUS FEEDSTOCK” (attorney docket no. FN-0017 US NP1); and Ser. No. ______, entitled “PROCESSES FOR MAKING SYNGAS-DERIVED PRODUCTS” (attorney docket no. FN-0012 US NP1). All of the above are incorporated herein by reference for all purposes as if fully set forth.

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present invention be limited to the specific values recited when defining a range.

When the term “about” is used in describing a value or an end-point of a range, the invention should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting.

### Petroleum Coke

The term “petroleum coke” as used herein includes both (i) the solid thermal decomposition product of high-boiling hydrocarbon fractions obtained in petroleum processing (heavy residues—“resid petcoke”) and (ii) the solid thermal decomposition product of processing tar sands (bituminous sands or oil sands—“tar sands petcoke”). Such carbonization products include, for example, green, calcined, needle and fluidized bed petroleum coke.

Resid petcoke can be derived from a crude oil, for example, by coking processes used for upgrading heavy-gravity residual crude oil, which petroleum coke contains ash as a minor component, typically about 1.0 wt % or less, and more typically about 0.5 wt % or less, based on the weight of the coke. Typically, the ash in such lower-ash cokes predominantly comprises metals such as nickel and vanadium.

Tar sands petcoke can be derived from an oil sand, for example, by coking processes used for upgrading oil sand. Tar sands petcoke contains ash as a minor component, typically in the range of about 2 wt % to about 12 wt %, and more typically in the range of about 4 wt % to about 12 wt %, based on the overall weight of the tar sands petcoke. Typically, the ash in such higher-ash cokes predominantly comprises materials such as compounds of silicon and/or aluminum.

Petroleum coke in general has an inherently low moisture content typically in the range of from about 0.2 to about 2 wt % (based on the total petroleum coke weight); it also typically has a very low water soaking capacity to allow for conventional catalyst impregnation methods.

The petroleum coke can comprise at least about 70 wt % carbon, at least about 80 wt % carbon, or at least about 90 wt % carbon, based on the total weight of the petroleum coke. Typically, the petroleum coke comprises less than about 20 wt % percent inorganic compounds, based on the weight of the petroleum coke.

### Alkali Metal Gasification Catalyst

Particulate compositions according to the present invention are based on the above-described petroleum coke and further comprise an amount of an alkali metal gasification catalyst, for example, an alkali metal component, as alkali metal and/or a compound containing alkali metal. Suitable alkali metals are selected from the group consisting of lithium, sodium, potassium, rubidium, cesium, and mixtures thereof. Particularly useful are potassium sources. In embodiments of the invention, the alkali metal gasification catalyst comprises an alkali metal hydroxide and one or more other alkali metal compounds.

Suitable alkali metal hydroxides are selected from the group consisting of hydroxide salts of sodium, potassium, rubidium, lithium, cesium, and mixtures thereof. In particular embodiments, the alkali metal hydroxide comprises potassium hydroxide.

Typically, the weight ratio of the alkali metal hydroxide to one or more other alkali metal compounds in the particulate composition ranges from about 0.01, or from about 0.03, or from about 0.05, or from about 0.07, to about 0.15, or to about 0.2, or to about 0.3, or to about 0.5.

Suitable other alkali metal compounds are selected from the group consisting of alkali metal carbonates, bicarbonates, formates, oxalates, amides, acetates, sulfides, halides, and nitrates. For example, the catalyst can comprise one or more of Na₂CO₃, K₂CO₃, Rb₂CO₃, Li₂CO₃, Cs₂CO₃, and particularly, potassium carbonate.

Co-catalysts or other catalyst additives may be utilized, as disclosed in various of the previously incorporated references.

### Particulate Composition

Typically, the petroleum coke sources can be supplied as a fine particulate having an average particle size of from about 25 microns, or from about 250 microns, up to about 500, or up to about 2500 microns. One skilled in the art can readily determine the appropriate particle size for the individual particulates and the particulate composition. For example, when a fluid bed gasification reactor is used, the particulate composition can have an average particle size which enables incipient fluidization of the particulate composition at the gas velocity used in the fluid bed gasification reactor.

At least a portion of the particulate composition comprises the alkali metal gasification catalyst. Optionally, co-catalyst/catalyst additives as disclosed in the previously incorporated references can be used as well. Typically, the alkali metal gasification catalyst is present in an amount sufficient to provide, in the particulate composition, a ratio of alkali metal atoms to carbon atoms ranging from about 0.01, or from about 0.02, or from about 0.03, or from about 0.04, up to about 0.08, or up to about 0.07, or up to about 0.06. Additionally, the alkali metal hydroxide is typically at least about 1 wt %, or at least about 3 wt %, or at least about 5 wt %, or at least about 10 wt % of the combined weight of the petroleum coke particulates and the alkali metal gasification catalyst.

Typically, carbonaceous materials, such as petroleum coke, may include quantities of inorganic matter including calcium and aluminum which form inorganic oxides (“ash”) in the gasification reactor. At temperatures above about 500 to 600° C., potassium and other alkali metals can react with ash to form insoluble alkali aluminosilicates. In this form, the alkali metal is inactive as a catalyst. To prevent buildup of the inorganic residue in a gasification reactor, a solid purge of char, i.e., solids composed of ash, unreacted carbonaceous material, and alkali metal bound within the solids, are routinely withdrawn. Catalyst loss in the solid purge is generally compensated by a catalyst make-up stream.

The overall ash (ash+catalyst) content of the particulate composition can be, for example, about 20 wt % or less, about 15 wt % or less, about 10 wt % or less, or about 5 wt % or less, depending on the starting ash in the coke source.

The particulate composition should have a high percentage of carbon, and thus btu/lb value and methane product per unit weight of the particulate composition. In certain embodiments, the particulate composition has a carbon content ranging from about 75 wt %, or from about 80 wt %, or from about 85 wt %, or from about 90 wt %, up to about 95 wt %, based on the weight of the petcoke.

### Methods for Making the Particulate Composition

The petroleum coke for use in the preparation of the particulate composition can require initial processing to prepare the particulate composition for gasification.

The petroleum coke for the particulate composition can be crushed and/or ground according to any methods known in the art, such as impact crushing and wet or dry grinding to yield particulates. Depending on the method utilized for crushing and/or grinding of the petroleum coke, the resulting particulates can need to be sized (e.g., separated according to size) to provide an appropriate feedstock.

Any method known to those skilled in the art can be used to size the particulates. For example, sizing can be preformed by screening or passing the particulates through a screen or number of screens. Screening equipment can include grizzlies, bar screens, and wire mesh screens. Screens can be static or incorporate mechanisms to shake or vibrate the screen. Alternatively, classification can be used to separate the petroleum coke particulates. Classification equipment can include ore sorters, gas cyclones, hydrocyclones, rake classifiers, rotating trommels, or fluidized classifiers. The petroleum coke can be also sized or classified prior to grinding and/or crushing.

Additional feedstock processing steps may be necessary depending on the qualities of petroleum coke. Feedstock deficient in ion-exchange sites can be pre-treated to create additional ion-exchange sites to facilitate catalysts loading and/or association. Such pre-treatments can be accomplished by any method known to the art that creates ion-exchange capable sites and/or enhances the porosity of the carbonaceous feed (see, for example, previously incorporated U.S. Pat. No. 4,468,231 and GB1599932). Often, pre-treatment is accomplished in an oxidative manner using any oxidant known to the art.

Typically, the coke is wet ground and sized (e.g., to an average particle size ranging from about 25 microns to about 2500 microns) and then drained of its free water (i.e., dewatered) to yield a wet cake consistency. Examples of suitable methods for the wet grinding, sizing, and dewatering are known to those skilled in the art, as disclosed in previously incorporated U.S. patent application Ser. No. 12/178,380 (filed 23 Jul. 2008).

The filter cake of the coke particulate formed by the wet grinding in accordance with one embodiment of the present invention can have a moisture content ranging from about 40% to about 60%, about 40% to about 55%, or about 50%. It will be appreciated by one of ordinary skill in the art that the moisture content of dewatered wet ground coke depends on the particular type of the coke, the particle size distribution, and the particular dewatering equipment used.

The coke particulate is subsequently treated to associate at least a first catalyst (e.g., an alkali metal gasification catalyst). In some embodiments, a second catalyst (e.g., a co-catalyst) can be provided to the coke particulate; in such instances, the coke particulate can be treated in separate processing steps to provide the first catalyst and second catalyst. For example, the primary gasification catalyst can be supplied to the coke particulate (e.g., a potassium and/or sodium source), followed by a separate treatment to provide a calcium gasification co-catalyst source to the coke. Alternatively, the first and second catalysts can be provided as a mixture in a single treatment (see previously incorporated US2007/0000177A1).

Any methods known to those skilled in the art can be used to associate alkali metal gasification catalysts with the coke particulate. Such methods include but are not limited to, admixing with a solid catalyst source and/or impregnating the catalyst onto coke particulate. Several impregnation methods known to those skilled in the art can be employed to incorporate the gasification catalysts. These methods include but are not limited to, incipient wetness impregnation, evaporative impregnation, vacuum impregnation, dip impregnation, and combinations of these methods. Gasification catalysts can be impregnated into the coke particulate by slurrying with a solution (e.g., aqueous) of the catalyst and alkali metal hydroxide.

When the coke particulate is slurried with a solution of the catalyst, the resulting slurry can be dewatered to provide a catalyzed coke particulate, again typically, as a wet cake. The solution of catalyst for slurrying the coke particulate can be prepared from any source in the present methods, including fresh or make-up catalyst and recycled catalyst or catalyst solution (infra). Methods for dewatering the slurry to provide a wet cake of the catalyzed coke particulate include filtration (gravity or vacuum), centrifugation, and a fluid press.

In some embodiments, a small amount of organic wetting agent may be added to the wet coke solution to facilitate pore wetting and diffusion. Suitable wetting agents do not generally contain substantial amounts of elements, such as phosphorus or boron, which can build up as impurities if the catalyst solution is recycled. Suitable wetting agents include, but are not limited to, non-ionic surfactants (e.g., TRITON CF-10, TRITON CF-21, alkyl polyglucosides, and the like), sulfate or sulfonate anionic surfactants (e.g., TRITON QS-15 and the like), alkyldiphenyloxide disulfonate salts (e.g., FAX-2A1), ethylene oxide/propylene oxide copolymers, and actylphenol ethoxylates (e.g., TRITON BG-10, TERGITOL L, TRITON X, and the like).

Additionally, in some embodiments, the coke is separated into two fractions, where the weight ratio of one fraction to the other can range from about 1:1 to about 9:1. In a particular embodiment, the coke is wet-ground and dewatered prior to separating it into the two fractions. In this embodiment, the catalyst is loaded only onto the fraction having the larger mass of coke (if the masses of the two fractions are different). After loading the catalyst onto one fraction, the catalyst-loaded fraction is dewatered and thoroughly mixed with the other non-catalyst-loaded fraction. In another particular embodiment, coke is separated into two fractions, where one fraction is wet ground and the other is dry ground. The catalyst is then loaded only onto the wet-ground fraction. After catalyst loading, the wet-ground fraction is dewatered and thoroughly mixed with the dry-ground fraction, and the resulting blend is dried.

The slurried coke particulate can be dried according to methods known to those skilled in the art. In some embodiments, the wet coke cake is thermally treated under a counter-current stream of dry inert gas until the moisture content of the coke cake is less than about 6 wt %, or less than about 4 wt %. In these embodiments, suitable inert gases include nitrogen, argon, CO/H₂ fresh gas, CO/H₂ recycled gas, and mixtures thereof. In embodiments where drying comprises exposure to elevated temperature ranges, the suitable temperature profile will depend on the composition and grade of the coke. Other suitable drying methods include treatment with superheated steam to vaporize the liquid, evaporation of the solution, or other methods employed by those skilled in the art.

For embodiments that involve combining two or more feedstocks of coke (e.g., a catalyst-loaded fraction and a non-catalyst-loaded fraction), these feedstocks can be combined by any methods known to those skilled in the art including, but not limited to, kneading, and vertical or horizontal mixers, for example, single or twin screw, ribbon, or drum mixers.

The dried particulate composition can be stored for future use or transferred to a feed operation for introduction into a gasification reactor. The particulate composition can be conveyed to storage or feed operations according to any methods known to those skilled in the art, for example, a screw conveyer or pneumatic transport.

In a further aspect, the invention provides a process for preparing a particulate composition of the invention, the process comprising the steps of: (a) providing petroleum coke particulates, alkali metal hydroxide, and one or more other alkali metal compounds; (b) contacting the coke particulates with an aqueous solution comprising an alkali metal hydroxide to form a slurry; (c) dewatering the slurry to form a wet coke cake loaded with the alkali metal hydroxide; (d) contacting the coke particulates with an aqueous solution comprising the one or more other alkali metal compounds; (e) dewatering the slurry to form a wet coke cake loaded with the alkali metal hydroxide and the one or more alkali metal compounds; and (f) drying the wet coke cake to produce a particulate composition having a moisture content of less than about 6 wt %.

In yet a further aspect, the invention provides a process for preparing a particulate composition of the invention, the process comprising the steps of: (a) providing petroleum coke particulates; (b) providing particulates of alkali metal hydroxide and one or more alkali metal compounds suitably sized for solid blending with the petroleum coke particulates; and (c) blending the coke particulates with the particulates of the alkali metal hydroxide and one or more other alkali metal compounds. The particulates may be ground and sized according to any suitable method known to those of skill in the art. The blending of the ground components may occur by any suitable method known to those of skill in the art. Depending on the moisture content of the blended composition, the composition may be subjected to an additional step of drying the blended particulate composition to produce a particulate composition having a moisture content of less than about 6 wt %.

In any process of preparing the particulate composition of the invention, the preparation environment preferable remains substantially free of air, particularly oxygen.

### Catalytic Gasification Methods

The particulate compositions of the present invention are particularly useful in integrated gasification processes for converting petroleum coke to combustible gases, such as methane. The gasification reactors for such processes are typically operated at moderately high pressure and temperature, requiring introduction of the particulate composition to the reaction zone of the gasification reactor while maintaining the required temperature, pressure, and flow rate of the feedstock. Those skilled in the art are familiar with feed systems for providing feedstocks to high pressure and/or temperature environments, including, star feeders, screw feeders, rotary pistons, and lock-hoppers. It should be understood that the feed system can include two or more pressure-balanced elements, such as lock hoppers, which would be used alternately.

In some instances, the particulate composition can be prepared at pressures conditions above the operating pressure of gasification reactor. Hence, the particulate composition can be directly passed into the gasification reactor without further pressurization.

Suitable gasification reactors include counter-current fixed bed, co-current fixed bed, fluidized bed, entrained flow, and moving bed reactors. The gasification reactor typically will be operated at temperatures of at least about 450° C., or of at least about 600° C. or above, to about 900° C., or to about 750° C., or to about 700° C.; and at pressures of at least about 50 psig, or at least about 200 psig, or at least about 400 psig, to about 1000 psig, or to about 700 psig, or to about 600 psig.

The gas utilized in the gasification reactor for pressurization and reactions of the particulate composition typically comprises steam, and optionally, oxygen, air, CO, and/or H₂, and is supplied to the reactor according to methods known to those skilled in the art. Typically, the carbon monoxide and hydrogen produced in the gasification is recovered and recycled. In some embodiments, however, the gasification environment remains substantially free of air, particularly oxygen. In one embodiment of the invention, the reaction of the carbonaceous feedstock is carried out in an atmosphere having less than about 1% oxygen by volume.

Any of the steam boilers known to those skilled in the art can supply steam to the reactor. Such boilers can be powered, for example, through the use of any carbonaceous material such as powdered coal, biomass etc., and including but not limited to rejected carbonaceous materials from the particulate composition preparation operation (e.g., fines, supra). Steam can also be supplied from a second gasification reactor coupled to a combustion turbine where the exhaust from the reactor is thermally exchanged to a water source and produce steam.

Recycled steam from other process operations can also be used for supplying steam to the reactor. For example, when the slurried particulate composition is dried with a fluid bed slurry drier, as discussed previously, the steam generated through vaporization can be fed to the gasification reactor.

The small amount of required heat input for the catalytic coke gasification reaction can be provided by superheating a gas mixture of steam and recycle gas feeding the gasification reactor by any method known to one skilled in the art. In one method, compressed recycle gas of CO and H₂ can be mixed with steam and the resulting steam/recycle gas mixture can be further superheated by heat exchange with the gasification reactor effluent followed by superheating in a recycle gas furnace.

A methane reformer can be included in the process to supplement the recycle CO and H₂ fed to the reactor to ensure that the reaction is run under thermally neutral (adiabatic) conditions. In such instances, methane can be supplied for the reformer from the methane product, as described below.

Reaction of the particulate composition under the described conditions typically provides a crude product gas and a char. The char produced in the gasification reactor during the present processes typically is removed from the gasification reactor for sampling, purging, and/or catalyst recovery. Methods for removing char are well known to those skilled in the art. One such method taught by EP-A-0102828, for example, can be employed. The char can be periodically withdrawn from the gasification reactor through a lock hopper system, although other methods are known to those skilled in the art.

Crude product gas effluent leaving the gasification reactor can pass through a portion of the gasification reactor which serves as a disengagement zone where particles too heavy to be entrained by the gas leaving the gasification reactor are returned to the fluidized bed. The disengagement zone can include one or more internal cyclone separators or similar devices for removing particulates from the gas. The gas effluent passing through the disengagement zone and leaving the gasification reactor generally contains CH₄, CO₂, H₂, CO, H₂S, NH₃, unreacted steam, entrained fines, and other contaminants such as COS.

Residual entrained fines can also be removed by any suitable means such as external cyclone separators followed by Venturi scrubbers. The recovered fines can be processed to recover alkali metal catalyst.

Processes have been developed to recover alkali metal from the solid purge in order to reduce raw material costs and to minimize environmental impact of a CCG process. The char can be quenched with recycle gas and water and directed to a catalyst recycling operation for extraction and reuse of the alkali metal catalyst. Particularly useful recovery and recycling processes are described in U.S. Pat. No. 4,459,138, as well as previously incorporated U.S. Pat. No. 4,057,512, US2007/0277437A1, U.S. patent application Ser. No. ______, entitled “CATALYTIC GASIFICATION PROCESS WITH RECOVERY OF ALKALI METAL FROM CHAR” (attorney docket no. FN-0007 US NP1), U.S. patent application Ser. No. ______, entitled “CATALYTIC GASIFICATION PROCESS WITH RECOVERY OF ALKALI METAL FROM CHAR” (attorney docket no. FN-0014 US NP1), U.S. patent application Ser. No. ______, entitled “CATALYTIC GASIFICATION PROCESS WITH RECOVERY OF ALKALI METAL FROM CHAR” (attorney docket no. FN-0015 US NP1), and U.S. patent application Ser. No. ______, entitled “CATALYTIC GASIFICATION PROCESS WITH RECOVERY OF ALKALI METAL FROM CHAR” (attorney docket no. FN-0016 US NP1). Reference can be had to those documents for further process details.

The gas stream from which the fines have been removed can then be passed through a heat exchanger to cool the gas and the recovered heat can be used to preheat recycle gas and generate high pressure steam. The gas stream exiting the Venturi scrubbers can be fed to COS hydrolysis reactors for COS removal (sour process) and further cooled in a heat exchanger to recover residual heat prior to entering water scrubbers for ammonia recovery, yielding a scrubbed gas comprising at least H₂S, CO₂, CO, H₂, and CH₄. Methods for COS hydrolysis are known to those skilled in the art, for example, see U.S. Pat. No. 4,100,256.

The residual heat from the scrubbed gas can be used to generate low pressure steam. Scrubber water and sour process condensate can be processed to strip and recover H₂S, CO₂ and NH₃; such processes are well known to those skilled in the art. NH₃ can typically be recovered as an aqueous solution (e.g., 20 wt %).

A subsequent acid gas removal process can be used to remove H₂S and CO₂ from the scrubbed gas stream by a physical absorption method involving solvent treatment of the gas to give a cleaned gas stream. Such processes involve contacting the scrubbed gas with a solvent such as monoethanolamine, diethanolamine, methyldiethanolamine, diisopropylamine, diglycolamine, a solution of sodium salts of amino acids, methanol, hot potassium carbonate or the like. One method can involve the use of Selexol® (UOP LLC, Des Plaines, Ill. USA) or Rectisol® (Lurgi AG, Frankfurt am Main, Germany) solvent having two trains; each train consisting of an H₂S absorber and a CO₂ absorber. The spent solvent containing H₂S, CO₂ and other contaminants can be regenerated by any method known to those skilled in the art, including contacting the spent solvent with steam or other stripping gas to remove the contaminants or by passing the spent solvent through stripper columns. Recovered acid gases can be sent for sulfur recovery processing. The resulting cleaned gas stream contains mostly CH₄, H₂, and CO and, typically, small amounts of CO₂ and H₂O. Any recovered H₂S from the acid gas removal and sour water stripping can be converted to elemental sulfur by any method known to those skilled in the art, including the Claus process. Sulfur can be recovered as a molten liquid.

In certain embodiments of the invention, the plurality of gaseous products are at least partially separated to form a gas stream comprising a predominant amount of one of the gaseous products. For example, the cleaned gas stream can be further processed to separate and recover CH₄ by any suitable gas separation method known to those skilled in the art including, but not limited to, cryogenic distillation and the use of molecular sieves or ceramic membranes. One method for recovering CH₄ from the cleaned gas stream involves the combined use of molecular sieve absorbers to remove residual H₂O and CO₂ and cryogenic distillation to fractionate and recover CH₄. Typically, two gas streams can be produced by the gas separation process, a methane product stream and a syngas stream (H₂ and CO). The syngas stream can be compressed and recycled to the gasification reactor. If necessary, a portion of the methane product can be directed to a reformer, as discussed previously and/or a portion of the methane product can be used as plant fuel.

Further process details can be had by reference to the previously incorporated patents and publications.

### EXAMPLES

### Example 1

### Petroleum Coke Sample Preparation

When the as-received petroleum coke is found to be too damp (i.e. not free-flowing) to be jaw-crushed, it is necessary to first air-dry it in a mechanical-convection oven at 35° C. for an extended period of time. Stage-crushing was performed carefully so as not to generate excessive fines and to maximize the amount of material having particle sizes below about 850 microns.

An analysis of a tar sands petroleum coke sample provided results as follows: 0.22 percent by weight moisture, 0.28 percent by weight ash (proximate analysis); carbon 88.81 percent, sulfur 5.89 percent and a btu/lb value of 15,210. The ash component of the petroleum coke contained 6.69 percent silica and 2.56 percent alumina, based on the weight of the ash.

Finely ground petroleum coke (with particle size between about 300 and 850 microns) was added to an Erlenmeyer flask, and a soaking solution of potassium hydroxide and potassium carbonate was added to the flask forming a slurry. The slurry density was maintained at approximately 20 wt % in the flask. The air inside the flask was displaced with nitrogen and the flask was sealed. The flask was then placed on a shaker bath and was stirred for 4 hours at room temperature. The treated coke was dewatered by filtering over a vibratory screen with a mesh size of about +325 to yield a wet coke cake loaded with potassium hydroxide and potassium carbonate.

### Example 2

### Petroleum Coke Particulate Composition Gasification

Gasifications of the particulate composition from Example 1 were carried out in a high-pressure apparatus that included a quartz reactor. About a 100 mg of each sample was separately charged into a platinum cell held in the reactor and gasified. Typical gasification conditions were: total pressure, 500 psig; temperature, about 700° C.; and reaction times, up to 3 hr.; in an atmosphere of 66% H₂O, 25.4% H₂, and 8.6% CO.

### Example 3

### Carbon Conversion for Samples of Coke Particulate

Three separate samples were prepared for gasification. In the first sample (PCC-007-S2B), the ground coke was soaked in a 15% potassium carbonate solution. In the second sample (PCC-039-S2I), the ground coke was soaked in a 15%-K₂CO₃-equivalent potassium hydroxide solution. In the third sample (PCC-043-S2L), the ground coke was soaked in a 15%-K₂CO₃-equivalent solution of potassium carbonate and potassium hydroxide (90% and 10%, respectively).

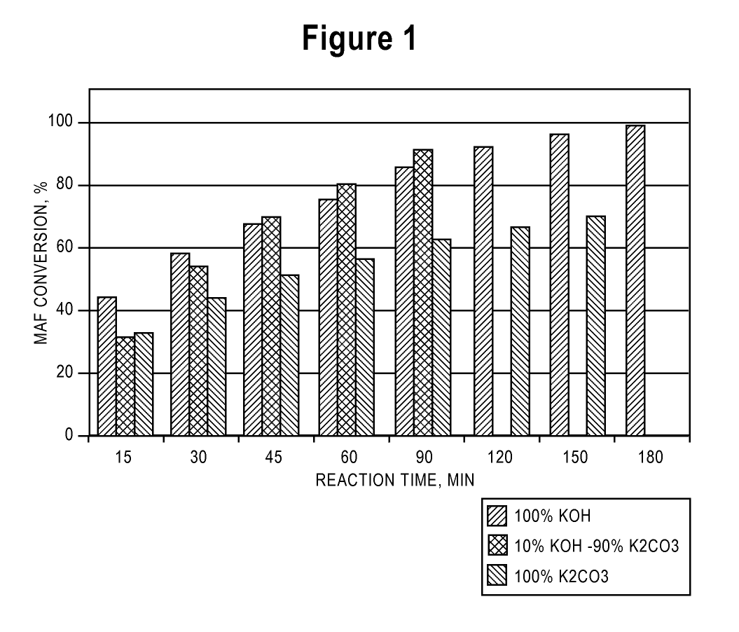

FIG. 1 shows the carbon conversion as a function of time for the three samples. Over the duration of the test, the sample treated with the soaking solution containing both potassium hydroxide and potassium carbonate showed the highest rate of carbon conversion. This sample had undergone full conversion 30-60 minutes before the other two samples. Because the three samples all had equivalent amounts of potassium, the amount of alkali metal present could not in and of itself account for this improvement in the rate of carbon conversion. The absence of data for one or more samples at 120 minutes, 150 minutes, and 180 minutes indicates that the gasification experiment had been terminated.

We claim:

1. A particulate composition having a particle distribution size suitable for gasification in a fluidized bed zone, the particulate composition comprising an intimate mixture of (a) a petroleum coke; and (b) an alkali metal gasification catalyst which, in the presence of steam and under suitable temperature and pressure, exhibits gasification activity whereby a plurality of gases including methane and at least one or more of hydrogen, carbon monoxide, carbon dioxide, hydrogen sulfide, ammonia, and other higher hydrocarbons are formed, wherein:
(i) the alkali metal gasification catalyst comprises a combination of an alkali metal hydroxide with one or more other alkali metal compounds selected from the group consisting of an alkali metal carbonate, alkali metal bicarbonate, alkali metal formate, alkali metal oxalate, alkali metal amide, alkali metal acetate, alkali metal sulfide, alkali metal halide, and alkali metal nitrate;
(ii) the weight ratio of the alkali metal hydroxide to the other alkali metal compounds, in the alkali metal gasification catalyst, ranges from about 0.01 to about 0.5;
(iii) the alkali metal gasification catalyst is present in an amount sufficient to provide, in the particulate composition, a ratio of alkali metal atoms to carbon atoms ranging from about 0.01 to about 0.08; and
(iv) the particulate composition has a moisture content of less than about 6 wt % based on the weight of the particulate composition.

2. The particulate composition according to claim 1, wherein the alkali metal gasification catalyst comprises a potassium compound, a sodium compound or both.

3. The particulate composition according to claim 1, wherein the alkali metal gasification catalyst comprises a potassium compound.

4. The particulate composition according to claim 1, wherein the one or more other alkali metal compounds comprises potassium carbonate.

5. The particulate composition according to claim 1, wherein the alkali metal hydroxide comprises potassium hydroxide.

6. The particulate composition according to claim 1, wherein the particulate composition comprises about 20 wt % or less overall ash content.

7. The particulate composition according to claim 1, having a particle size ranging from about 25 microns to about 2500 microns.

8. The particulate composition according to claim 1, wherein the alkali metal hydroxide is at least about 1 wt % based on the combined weight of the petroleum coke and the alkali metal gasification catalyst.

9. The particulate composition according to claim 1, wherein the alkali metal gasification catalyst comprises a potassium compound, a sodium compound or both; the particulate composition comprises about 20 wt % or less overall ash content; and the particulate composition has a particle size ranging from about 25 microns to about 2500 microns.

10. A process for converting a particulate composition into a plurality of gaseous products, the process comprising the steps of:
(a) supplying a particulate composition according to claim 1 to a gasifying reactor;
(b) reacting the particulate composition in the gasifying reactor in the presence of steam and under suitable temperature and pressure to form a plurality of gaseous including methane and at least one or more of hydrogen, carbon monoxide, carbon dioxide, hydrogen sulfide, ammonia and other higher hydrocarbons; and
(c) at least partially separating the plurality of gaseous products to produce a stream comprising a predominant amount of one of the gaseous products.

11. The process according to claim 10, wherein the stream comprises a predominant amount of methane.

12. The process according to claim 10, wherein a char is formed in step (b), and the char is removed from the gasifying reactor and sent to a catalyst recovery and recycle process.

13. The process according to claim 12, wherein alkali metal catalyst is recovered and recycled.

14. A process for preparing the particulate composition of claim 1, the process comprising the steps of:
(a) providing petroleum coke particulates and an alkali metal gasification catalyst having a combination of an alkali metal hydroxide and one or more other alkali metal compounds, wherein the alkali metal hydroxide is at least about 1 weight percent of the combined weight of the petroleum coke particulates and the alkali metal gasification catalyst;
(b) contacting the coke particulates with an aqueous solution comprising the alkali metal gasification catalyst to form a slurry;
(c) dewatering the slurry to form a wet coke cake loaded with the alkali metal gasification catalyst; and
(d) drying the wet coke cake to produce a particulate composition having a moisture content of less than about 6 weight percent.
